(19) United States
(12) Patent Application Publication
(10) Pub. No.: US 2009/0231112 A1
(43) Pub. Date: Sep. 17, 2009

(54) SYSTEMS AND METHODS FOR FACILITATING AUTOMATION INVOLVING MULTIPLE DEVICES

(76) Inventors: Aaron Baalbergen, Miami, FL (US); Demian Martin, San Leandro, CA (US)

Correspondence Address: IPSG, P.C., P.O. BOX 700640, SAN JOSE, CA, 95170, US

(21) Appl. No.: 12/046,388

(22) Filed: Mar. 11, 2008

(51) Int. Cl. G08B 9/00

(52) U.S. Cl. 340/286.02

(57) ABSTRACT

A system for facilitating automation involving multiple devices is disclosed. The devices may include a first device utilizing a first protocol and a second device utilizing a second protocol. The system may include a wrapper for translating between the first protocol and a first message, translating between the first protocol and a second message, and/or translating between the first protocol and a third message. The first message contains configuration data for the first device. The second message contains a command for instructing the first device and/or the second device to perform at least one action. The third message contains an event representation for describing one or more events involving one or more of the devices. The system may also include a router for forwarding the first message, the second message, and/or the third message between at least the first device and the second device.

### BACKGROUND OF THE INVENTION

The present invention relates to automation, such as one or more of home automation, small business automation, factory automation, etc. In general, an arrangement for automation may involve control and/or interworking of multiple devices, such as one or more phones, security control panels, sensors, media players, and/or remote control devices. Typically, prior art automation arrangements may have various problems, such as license conflicts and complexity, as illustrated and discussed with reference to the example of FIG. 1.

FIG. 1 shows a schematic representation an example design of an example prior art automation arrangement 100 (hereinafter “arrangement 100”). Arrangement 100 may include a phone 152, a security panel 156, a motion sensor 160, a remote control device 154 (hereinafter “remote control 154”), and a media player 158. As an example, in designing arrangement 100, it may be desirable to implement phone software 102 of phone 152 utilizing Asterisk® phone software, available from Digium, Inc. (www.digium.com and www.asterisk.org); it may also be desirable to implement media player software 118 of media player 158 utilizing xine media player software, available from the xine-Project (www.xinehq.de); it may also be desirable to implement motion sensor 160 utilizing the Z-Wave standard controlled by the Z-Wave Alliance (www.Z-Wave.com). However, because Asterisk® phone software and xine media player software are under the General Public License (GPL) while the Z-Wave is a proprietary protocol, there may be license conflicts that render the above design of arrangement 100 impractical, as further discussed below.

In arrangement 100, based on the above-mentioned design, phone 152 may be coupled with security panel 156 and remote control 154 through Asterisk® management interfaces 104, 128, and 112; and links 108 and 106. Each of interface 104, interface 128, interface 112, link 108, and link 106 may be implemented utilizing the Asterisk® protocol, which is under the GPL. Media player 158 may be coupled with security panel 156 and remote control 154 through xine control interfaces 120, 126, and 114; and links 122 and 116. Each of interface 126, interface 120, interface 114, link 122, and link 116 may be implemented utilizing the xine protocol, which is also under the GPL. Motion sensor 160 may be coupled with security panel 156 through a Z-Wave interface 136, a Z-Wave interface 130, and a link 132. Interface 136, interface 130, and link 132 may need to be implemented utilizing the Z-Wave protocol, which is proprietary.

As can be readily appreciated by one of ordinary skill in the art, the coexistence of Asterisk® management interface 128 and Z-Wave interface 130 in security panel 156 may violate the GPL of Asterisk® management interface 128 since Z-Wave interface 130 is not under the GPL. Similarly, the coexistence of xine control interface 126 and Z-Wave interface 130 in security panel 156 may also violate the GPL of xine control interface 126.

In order to resolve the license conflicts in security panel 156, Z-Wave interface 130 may need to be replaced with an interface that complies with the GPL. However, the GPL interface for coupling security panel 156 and motion sensor 160 may not exist or may not be desirable. Alternatively, a proprietary phone system may need to be implemented from the ground up to replace the Asterisk® phone software 102, such that Asterisk® management interface 128 may be replaced with a proprietary interface that is not under the GPL. However, the implementation of such a proprietary phone system may incur substantially high costs and therefore may be impractical. Similarly, implementing a new media player system for replacing xine control interface 126 in security panel 156 may also be costly and impractical. As a result, arrangement 100 may be extremely difficult and expensive, if not impossible, to implement.

Further, as also illustrated in the example of FIG. 1, at least three interfaces according to three different protocols need to be implemented in security panel 156; at least two interfaces according to two different protocols need to be implemented in remote control 154. More devices in arrangement 100 may require more interfaces to be implemented based on different protocols in many of the devices in arrangement 100. The implementation requirements and the complexity in arrangement 100 may result in tremendously high implementation, management, and maintenance costs for arrangement 100.

### SUMMARY OF INVENTION

An embodiment of the present invention relates to a system for facilitating automation involving multiple devices. The devices may include a first device utilizing a first protocol and a second device utilizing a second protocol. The system may include a wrapper for translating between the first protocol and a first message, translating between the first protocol and a second message, and/or translating between the first protocol and a third message. The first message contains configuration data for the first device. The second message contains a command for instructing the first device and/or the second device to perform at least one action. The third message contains an event representation for describing one or more events involving one or more of the devices. The system may also include a router for forwarding the first message, the second message, and/or the third message between at least the first device and the second device.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a schematic representation an example design of an example prior art automation arrangement.

FIG. 2 shows a schematic representation of a system in accordance with one or more embodiments of the present invention for facilitating automation in an automation system/arrangement that involve multiple devices.

FIG. 3 shows a schematic representation of a relational database in accordance with one or more embodiments of the present invention.

FIG. 4 shows a schematic representation illustrating a collaborative system/arrangement for creating and/or changing standard device templates for automation systems in accordance with one or more embodiments of the present invention.

FIG. 5 shows a flowchart illustrating a rule that specifies relations among one or more events and/or one or more commands in accordance with one or more embodiments of the present invention.

FIG. 6 shows a schematic representation of an automation process involving one or more events and one or more commands in an automation system/arrangement in accordance with one or more embodiments of the present invention.

FIG. 7 shows a flowchart illustrating a setup process for an automation system in accordance with one or more embodiments of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

One or more embodiments of the present invention relate to a system for facilitating automation that involves multiple devices. The devices may include one or more devices that are in compliance with the GPL and one or more devices that are not in compliance with the GPL. For example, the devices may include an Asterisk® phone device and a motion sensor utilizing a Z-Wave interface. With the system according to the invention, the automation may be implemented without the problems of license conflicts and complexity in prior art arrangements.

The system may include a router for forwarding messages among the devices. The system may also include a one or more wrappers implemented in the router and/or in one or more of the devices involved in the automation. As an example, the system may include a first wrapper implemented in a first device among the devices. The first device may be implemented utilizing a first protocol, e.g., the Asterisk® protocol or the Z-Wave protocol. The first wrapper may translate between the first protocol and several types of messages. For example, the first wrapper may translate between the first protocol and a first message that contains configuration data for the first device. The configuration data may include one or more values for one or more operating parameters for the first device. For example, the operating parameters for the Asterisk® phone device may include the number of rings before a call is directed to a voicemail box, the speaker volume of the phone, and microphone volume of the phone, etc.

The first wrapper may also translate between the first protocol and a second message that contains at least a command. The command may instruct the first device and/or one or more other devices to perform one or more actions, such as making a phone call, turning on a light, etc.

The first wrapper may also translate between the first protocol and a third message that contains an event representation. As an example, the event representation may describe one or more events that involve one or more of the devices. As an example, an event may by represented by “Incoming Call,” “Sensor Tripped,” and/or “Media Ended.”

The router and the wrappers may facilitate the control and/or the interworking of the devices. Given the translation performed by the wrappers and the message forwarding performed by the router, the problem of license conflicts as existing in the prior art may be prevented. Further, the router and the wrappers may enable adding new devices in an automation arrangement without requiring adding new interfaces in other devices in the automation arrangement. Advantageously, the problems of complexity and high costs may be avoided.

In one or more embodiments, the present invention may relate to a method for facilitating automation involving multiple devices. The method may include translating between protocols and messages. The messages may contain configuration data, command messages, and/or event representations. The method may also include forwarding/routing the messages for setting up devices, triggering actions, reporting events, etc. The method may also prevent license conflicts and reduce costs in implementing automation arrangements.

The features and advantages of the invention may be better understood with reference to the figures and discussions that follow.

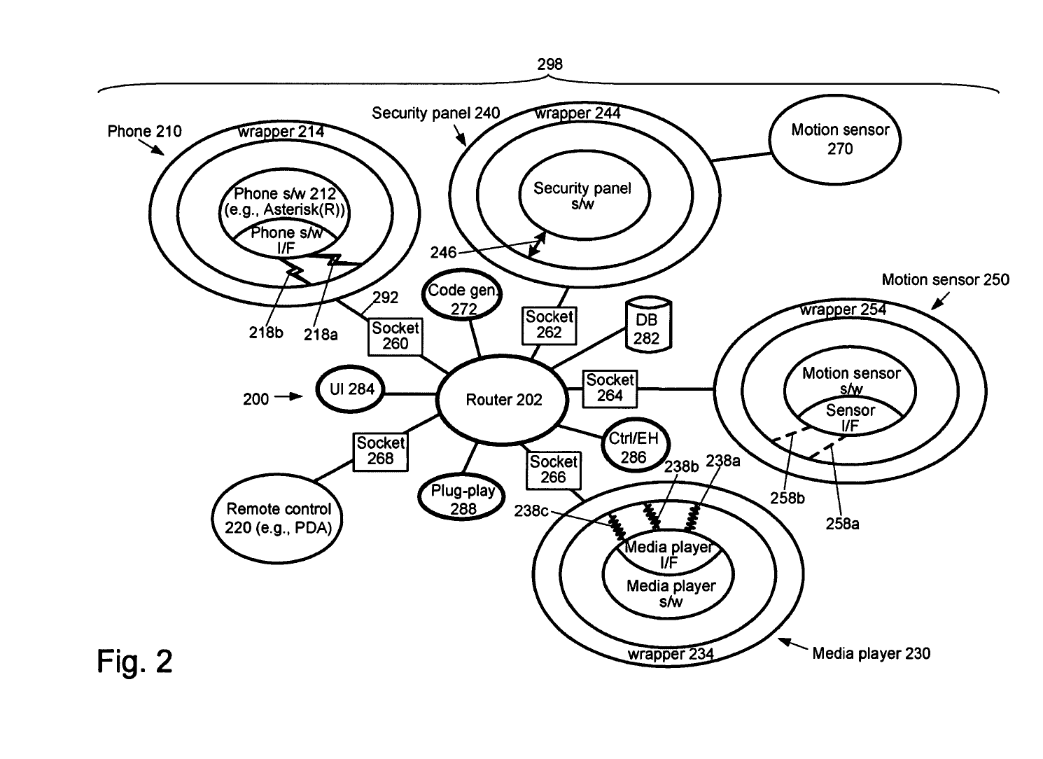

FIG. 2 shows a schematic representation of a system 200 in accordance with one or more embodiments of the present invention for facilitating automation in an automation system/arrangement 298 (hereinafter “arrangement 298”) that involve multiple devices. As an example, arrangement 298 may involve a phone 210 (such as an Asterisk® phone), a security panel 240, motion sensors 250 and 270, a media player 230 (such as a xine media player), and a remote control device 220 (such as a personal digital assistant, hereinafter “remote control 220”).

System 200 may include one or more of the following components: wrappers (such as wrappers 214, 244, 254, and 234), a router 202, a user interface element 284, a relational database 282, a control element 286 (or event handler 282), a plug-and-play module 288, and a code generator 272. The wrappers may translate between protocols and messages. The messages may include configuration data messages, command messages, and/or event representation messages. The messages may be called data/command/event messages, or DCE messages. Router 202 may be coupled with the devices through sockets, such as sockets 260, 262, 264, 266, and 268; router 202 may forward the messages among the devices through the sockets. User interface element 284 may provide a consistent, unified environment for a user to provide input, for example, related to configuration and/or control logic. Relational database 282 may store and correlate various data for facilitating the automation of the devices. Control element 286 may intercept event information in arrangement 298 and may control the forwarding of messages, for example, based on standard/default control logic and/or user-specified control logic. Plug-and-play module 288 may detect devices to be included in arrangement 298. Code generator 272 may automatically generate code for the wrappers based at least in part on templates stored in relational database 282. The components of system 200 are further discussed below utilizing phone 210 as an example.

For including phone 210 in arrangement 298, wrapper 214 may be implemented in phone 210 and/or router 202 to translate between phone system protocol messages (e.g., Asterisk® protocol messages 218a and 218b) and DCE messages (e.g., a DCE message 292). For example, configuration data, which include values for operating parameters for phone 210, may be received through user interface element 284 and may be sent to phone 210 in a configuration-data message. Wrapper 214 may translate the configuration-data message to obtain the values for the operating parameters according to the Asterisk® protocol. The values for the operating parameters may then be utilized by phone 210 for configuring Asterisk® software 212 (and/or relevant firmware in phone 210). As another example, command and event information generated by Asterisk® software 212 (and/or the firmware) may be translated by wrapper 214 into one or more command and/or event messages. The command and/or event messages may be forwarded by router 202 to one or more of the other devices for triggering/instructing actions, reporting status/events, etc.

Similarly, for example, wrapper 254 may translate between proprietary-wireless-protocol messages (e.g., Z-Wave messages 258a and 258b) and DCE messages; wrapper 234 may translate between media player protocol messages (e.g., xine messages 238a, 238b, and 238c) and DCE messages; etc.

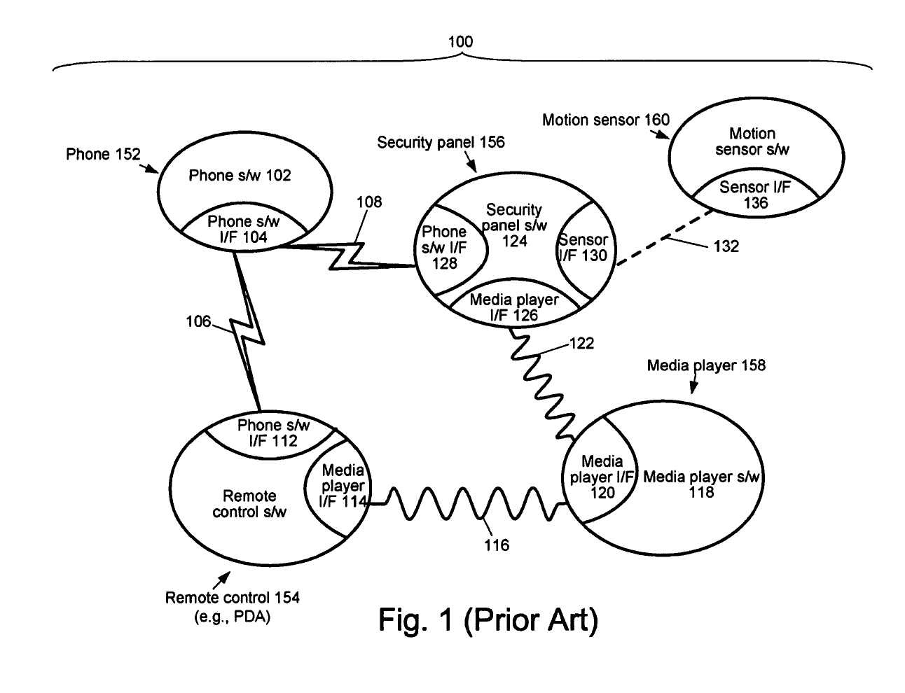

As can be appreciated from the example of FIG. 2, utilizing DCE messages, security panel 240 may communicate with phone 210 through a standard serial interface 246, wrapper 244, socket 262, router 202, socket 260, and wrapper 214 for various automation purposes. No additional interfaces (as interfaces 126, 128, and 130 required in the prior art arrangement 100 shown in the example of FIG. 1) need to be implemented in security panel 240 or any other devices in arrangement 298. According, there are no license conflicts in arrangement 298. Further, the implementation, management, and maintenance costs for arrangement 298 may be minimized.

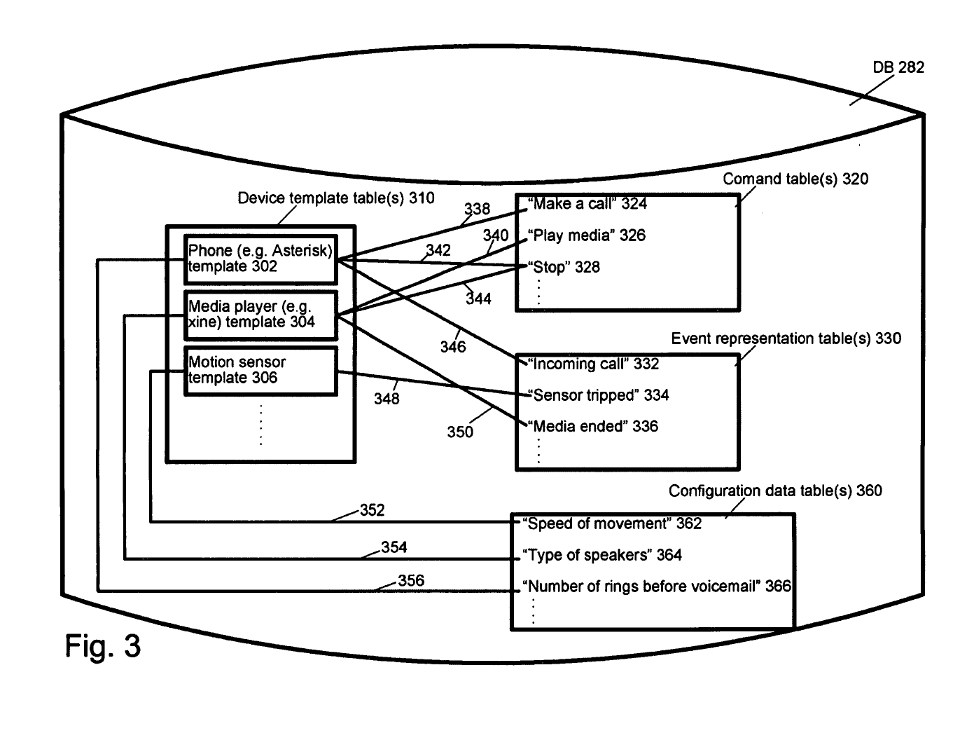

FIG. 3 shows a schematic representation of relational database 282 (also illustrated in the example of FIG. 2) in accordance with one or more embodiments of the present invention. Relational database 282 may include a device template table set 310, a command table set 320, an event representation table set 330, and a configuration data table set 360. Each of the table sets may include one or more data tables.

Device template table set 310 may include various device templates for various devices in arrangement 298 (illustrated in the example of FIG. 2). For example, device template table set 310 may include a phone template 302 (e.g., an Asterisk® template) for phone 210 (illustrated in the example of FIG. 2), a media player template 304 (e.g., a xine template) for media player 230 (illustrated in the example of FIG. 2), and a motion sensor template 306 for motion sensor 250 (illustrated in the example of FIG. 2). Relational database 282 may relate the device templates to various parameters (or data fields) and/or data values in command table set 320, event representation table set 330, and configuration data table set 360.

The device templates may be utilized by code generator 272 (illustrated in the example of FIG. 2) to automatically generate wrappers for one or more of the devices in arrangement 298. For example, phone template 302 may be utilized by code generator 272 for generating wrapper 214 (illustrated in the example of FIG. 2); media player template 304 may be utilized for generating wrapper 234 (illustrated in the example of FIG. 2); motion sensor template 306 may be utilized for generating wrapper 254 (illustrated in the example of FIG. 2).

The device templates may also be utilized by user interface element 284 (illustrated in the example of FIG. 2) to present appropriate configuration options to a user for receiving relevant user input. The user input may be utilized for customizing operating parameters of the devices and/or for customizing rules governing relations (e.g., logical relations, timing relations, etc.) among commands/events pertaining to the devices. For example, user interface element 284 may enable the user to choose the speaker volume when the user is configuring phone 210 and may enable the user to choose the sensitivity level when the user is configuring motion sensor 270. As another example, user interface element 284 may enable the user to relate the “Media is being Played” event with “Turn off the Light” command. Advantageously, a single, unified user interface may be provided for the user to configure various devices; the user may not need to learn different user interfaces for configuring different devices.

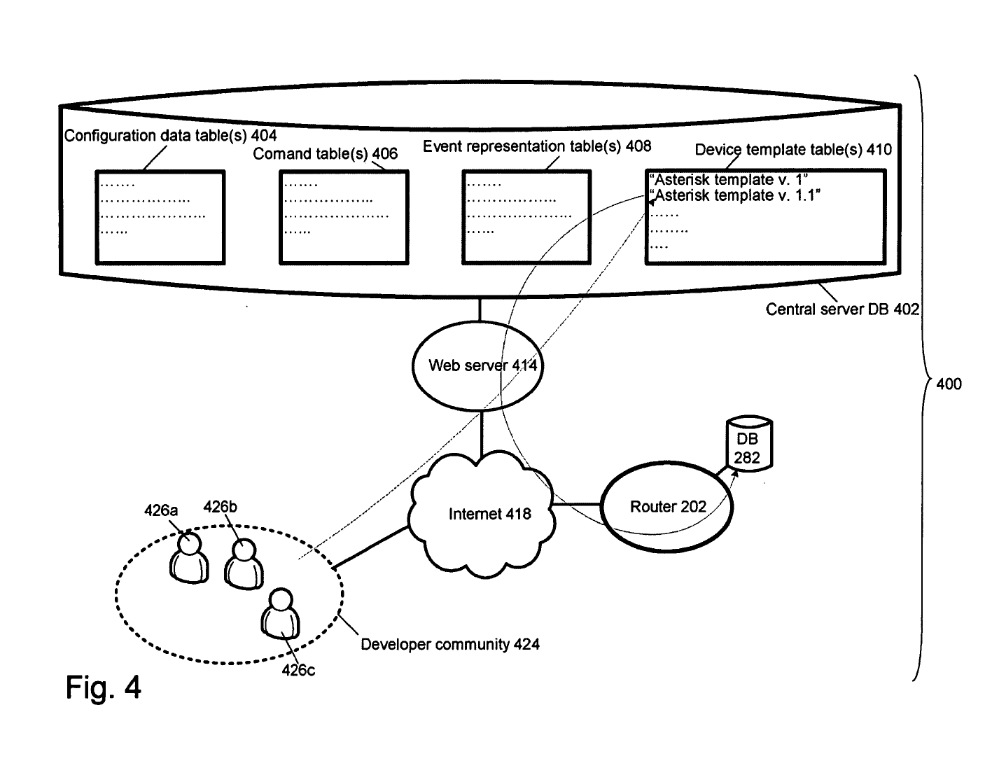

The device templates may also store configuration data The configuration data may include standard configuration data provided by a central server database (to be further discussed in the example of FIG. 4) and customized configuration data specified by a user. The configuration data may be provided to individual devices in configuration-data messages, which may be translated by wrappers to obtain values for operating parameters according to appropriate protocols. Accordingly, the configuration data for various devices are stored in one database separate from the devices. Advantageously, the user may utilize the stored configuration data of a device (e.g., a malfunctioning device) to conveniently configure a new, replacement device the need of going through many steps to reconfigure the new device.

Command table set 320 may contain commands that may be utilized for instructing one or more devices in arrangement 298 to perform one or more actions. Relational database 282 may correlate the commands with templates in device template table set 310. For example, command table set 320 may include a command “Make a Call” 324 related to a phone template 302 through link 338. Command table set 320 may also include a command “Play Media” 326 related to a media player template 304 through a link 340. Command table set 320 may also include a command “Stop” 328 related to phone template 302 through a link 342 and related to media player template 304 through a link 344. As an example, a user may send out command “Stop” 328 by pressing a stop button on remote control 220 (illustrated in the example of FIG. 2) when phone 210 and media player 230 are active. According to phone template 302, wrapper 214 may interpret command “Stop” 328 as “Hang up the Call.” On the other hand, according to media player template 304, wrapper 234 may interpret command “Stop” 328 as “Stop Playing the Media” Advantageously, the same signal received from the same control device may be utilized for instructing different devices to perform different actions. In one or more embodiments, motion sensor template 306 may not be related to any commands in command table set 320.

Event representation table set 330 may include descriptions/representations of various events pertaining to the devices in arrangement 298. For example, the event representations may include a representation “Incoming Call” 332 related to phone template 302 through a link 346, a representation “Sensor Tripped” 334 related to motion sensor template 306 through a link 348, and a representation “Media Ended” 336 related to media player template 304 through link 350.

Configuration data table set 360 may contain various parameters (or data fields) and/or data values pertaining to the configurations of one or more devices in arrangement 298. For example, configuration data table set 360 may include a parameter “Speed of Movement” 362 related to motion sensor template 306 through a link 352, a parameter “Type of Speakers” 364 related to media player template 304 through a link 354, and a parameter “Number of Rings before Voicemail” 366 related to phone template 302 through a link 356.

FIG. 4 shows a schematic representation illustrating a collaborative system/arrangement 400 (arrangement 400) for creating and/or changing standard device templates in accordance with one or more embodiments of the present invention. Arrangement 400 may include a central server database 402 for storing standard/default device templates, standard/default data, and standard/default rules. Central server database 402 may contain several data table sets: a configuration data table set 404 for storing standard/default configuration data (or operating parameter values) for various devices; a command table set 406 for storing standard/default commands for instructing actions to be performed by the devices; an event representation table set 408 for storing standard/default representations for events involving the devices; a device template table set 410 for storing device templates that contain standard/default data fields, data values, and/or rules. The rules may govern various relations among configuration data, commands, and events.

Central server database 402 may also be coupled with relational database 282 through router 202 and internet 418. Accordingly, depending on the devices in arrangement 298 (illustrated in the example of FIG. 2), relational database 282 may download applicable standard/default device templates, standard/default data, and standard/default rules from central server database 402.

Arrangement 400 may also include a web server 414. Central server database 402 may be coupled with a developer community 424 through web server 414 and the internet 418. Web server 414 may provide a user interface for creating and/or changing data fields and/or data values stored in central server database 402. Web server 414 may also facilitate creation and updates of device templates. Through internet 418 and web server 414, developers (such as developers 426a, 426b, and 426c) in developer community 424 may create new device templates. The developers may also change existing device templates by changing associated data fields, data values, and/or rules.

The creation and changes may be performed in a collaborative fashion, though the developers in developer community 424 may include employees of different organizations and/or enterprises. As an example, device template table set 410 may initially contain a standard Asterisk® template version 1 provided by Digium, Inc. Through internet 418, the standard Asterisk® template version 1 may be automatically downloaded to relational database 282. Through the user interface provided by web server 414, one or more developers in developer community 424 that are not Digium, Inc. employees may create a revised standard Asterisk® template version 1.1, for example, by adding more commands to Asterisk® template version 1. After the new standard Asterisk® template version 1.1 has been created, Asterisk® template version 1.1 may be pushed or pulled to relational database 482.

As can be appreciated from the example of FIG. 4, embodiments of the invention may leverage vast developer resource to enhance device templates. Advantageously, the performance and functionality of arrangement 298 may be effectively improved.

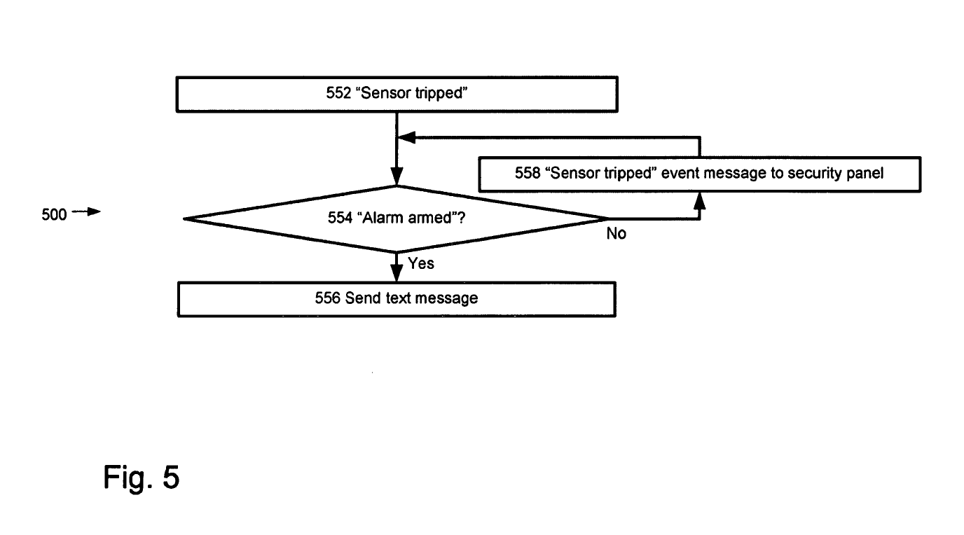

FIG. 5 shows a flowchart illustrating a rule 500 that specifies relations among one or more events and/or one or more commands in accordance with one or more embodiments of the present invention. As discussed in the example of FIG. 2, control element 286 (or an event handler) may intercept information concerning events involving the devices in arrangement 298. Based on the event information and predefined rules (e.g., logical relations), control element 286 may direct router 202 (shown in the example of FIG. 2) to forward messages to appropriate devices for triggering suitable commands and/or events. In the example rule 500 illustrated in FIG. 5, in step 552, control element 286 may monitor arrangement 298 and may receive information pertaining to an event “Sensor Tripped.” In step 554, control element 286 may determine whether there is an event “Alarm Armed” in arrangement 298. If the event “Alarm Armed” does not exist in arrangement 298, in step 558, control element 286 may trigger a “Sensor Tripped” event message to be sent to the security panel for arming the alarm. If the event “Alarm Armed” exists, in step 556, control element 286 may trigger a text message to be sent to the user of arrangement 298 for notifying the user of the relevant events, e.g., “Sensor Tripped” and “Sensor Tripped.”

Rule 500 may be easily defined by the user by linking data elements in relational database 282 without requiring the user or a technician to write code. Alternatively or additionally, rule 500 may be included in one or more standard device templates and/or other data downloaded to relational database 282 from central server database 402 (shown in the example of FIG. 4).

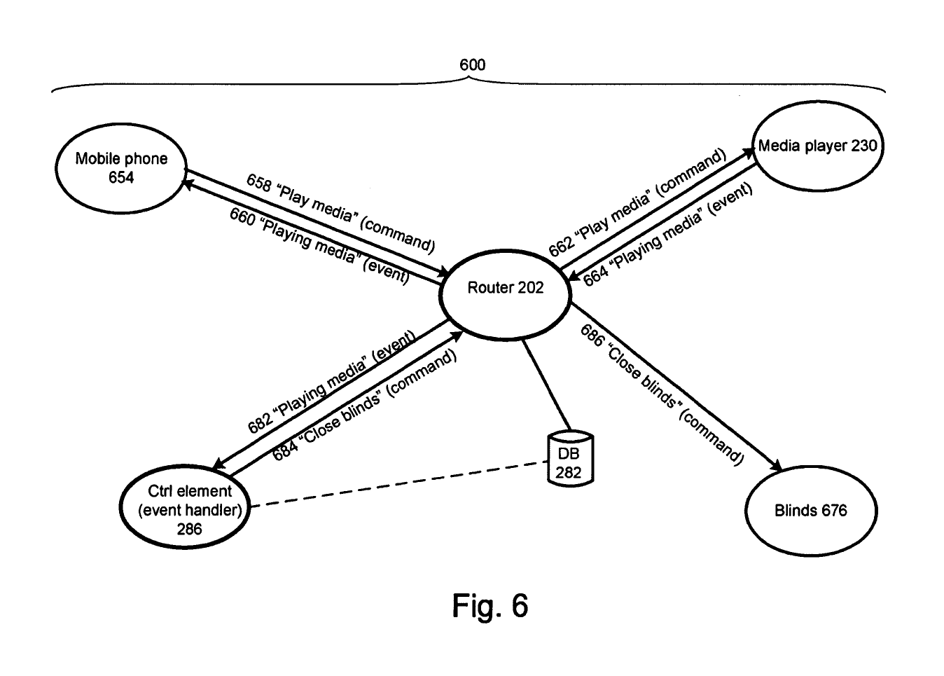

FIG. 6 shows a schematic representation of an automation process involving one or more events and one or more commands in an automation system/arrangement 600 (hereinafter “arrangement 600”) in accordance with one or more embodiments of the present invention. Arrangement may include router 202, control element 286, relational database 282, and wrappers similar to those discussed in the example of FIG. 2.

In step 658, mobile phone 654 may send a message containing a command “Play Media” to router 202.

In step 662, router 202 may forward the message containing the command “Play Media” to media player 230. Subsequently, wrapper 234 in media player 230 may translate the message to obtain the command “Play Media” according to the protocol utilized by media player 230. Accordingly, media player 230 may proceed with playing the requested media (e.g., an audio/video file).

In step 664, media player 230 may send a message containing a representation of the event “Playing Media” to router 202.

In step 660, router 202 may forward the message containing the event representation of “Playing Media” to mobile phone 654. Accordingly, mobile phone 654 may generate an indication and/or confirmation message through the user interface of mobile phone 654 for notifying the user of the event “Playing Media”

In step 682, router 202 may also send a copy of the message containing the event representation of “Playing Media” to control element 286. Control element 286 may check one or more rules that are stored in relational database 282 and related to the event “Playing Media”

In step 684, based on the event “Playing Media” and the related rule(s), control element 286 may send a message containing a command “Close Blinds” to router 202.

In step 686, router 202 may forward the message containing the command “Close Blinds” to blinds 676. Accordingly, blinds 676 may close.

In arrangement 600, the automation process is completed utilizing message translation and forwarding. No extra interfaces need to be implemented in the devices.

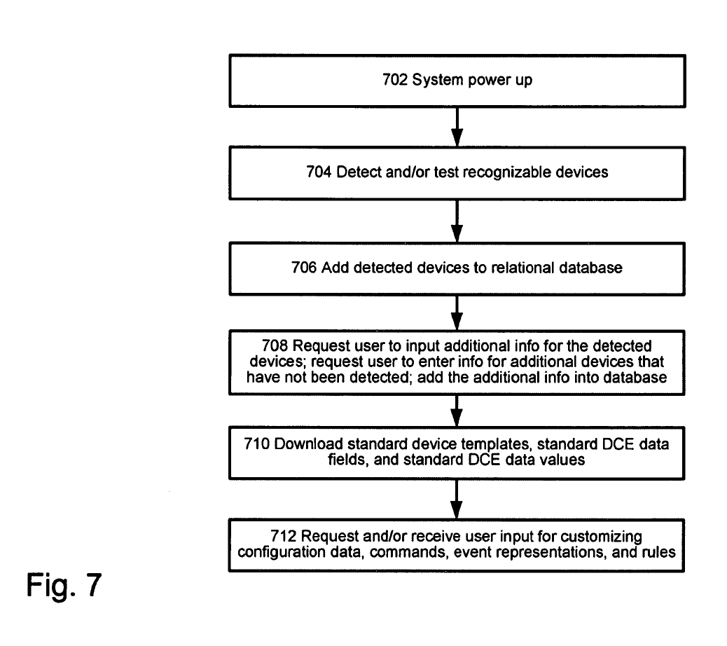

FIG. 7 shows a flowchart illustrating a setup process for system 200 and arrangement 298 (shown in the example of FIG. 2) in accordance with one or more embodiments of the present invention. The process may start with 702, in which the power of system 200 is up, i.e., system 200 is turned on.

In step 704, system 200 (or one or more plug-and-play modules, e.g., plug-and-play module 288) may detect and/or test recognizable devices through various connections. Plug-and-play module 288 may be configured to detect devices directly and indirectly connected to system 200. For example, plug-and-play module 288 may detect motion sensor 270, which is indirectly connected to router 202 through security panel 240.

In step 706, system 200 may add the detected devices to relational database 282.

In step 708, system 200 may request the user to enter information pertaining to additional devices that have not been detected. System 200 may also request the user to input additional information for the detected devices. For example, the additional device information may include the location of certain devices, for example, e.g., in which room a television is located. System 200 may also add the additional devices and additional device information to database 282.

In step 710, system 200 may download standard device templates from central server database 402 (shown in the example of FIG. 4). System 200 may also download standard data fields and data values for configuration data, commands, and/or event representations from central server database 402.

In step 712, system 200 may request and/or receive user input for customizing configuration data, commands, event representations, and rules for operating arrangement 298 (shown in the example of FIG. 2).

As can be appreciated from the foregoing, embodiments of the invention may prevent problems of license conflicts and complexity in implementing and operating automation systems/arrangements. Advantageously, implementation, management, and maintenance costs may be minimized. Further, more devices and more systems based on various protocols may be utilized in automation. As a result, the functionality and flexibility of automation systems/arrangements may be substantially enhanced.

Embodiments of the invention may also provide a unified user interface for configuring various devices and for customizing automation rules. Embodiments do not require users or installation technician to perform coding. Advantageously, embodiments of the invention enable easy and efficient configuration and customization.

Embodiments of the invention may also leverage vast, collaborative developer resource to enhance device templates. Advantageously, the performance and functionality of automation systems/arrangements may be may be improved in an efficient and effective fashion.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A system for facilitating automation, the automation involving a plurality of devices, the plurality of devices including at least a first device and a second device, the first device using a first protocol, the second device using a second protocol, the system comprising:
a first wrapper configured to perform at least two of
translating between the first protocol and a first message, the first message containing at least first-device configuration data, the first-device configuration data including one or more values for one or more operating parameters for the first device,
translating between the first protocol and a second message, the second message containing at least a first command, the first command configured to instruct at least one of the first device and the second device to perform at least a first action, and
translating between the first protocol and a third message, the third message containing at least a first event representation, the first event representation configured to describe one or more events, the one or more events involving one or more of the plurality of devices; and
a router coupled with the first device and coupled with the second device, the router configured to forward at least one of the first message, the second message, and the third message between at least the first device and the second device,
wherein the second protocol is different from the first protocol.

2. The system of claim 1 wherein the first protocol is under the General Public License, and the second protocol is not under the General Public License.

3. The system of claim 1 further comprising:
a first socket disposed between the first device and the router, the router coupled with the first device through the first socket; and
a second socket disposed between the second device and the router, the router coupled with the second device through the second socket.

4. The system of claim 1 wherein the one or more events involve one or more actions performed by at least the first device, and the first command is configured to instruct the second device to perform the first action.

5. The system of claim 4 wherein the first command is further configured to instruct a third device of the plurality of devices to perform a second action.

6. The system of claim 4 wherein the second device represents at least one of an audio/video device and a set of blinds, the first action including at least one of turning on the audio/video device, turning off the audio/video device, opening the blinds, and closing the blinds.

7. The system of claim 1 further comprising a relational database configured to store mapping relations between a first set of parameters according to the first protocol and the first device configuration data for the first device, between a second set of parameters according to the first protocol and the first command, and between a third set of parameters according to the first protocol and the first event representation.

8. The system of claim 7 wherein the relational database is further configured to store information pertaining to mapping between a first set of parameters according to the second protocol and the first command and mapping between a second set of parameters according to the second protocol and the first event representation.

9. The system of claim 7 wherein the relational database is further configured to store information pertaining to mapping between a first set of parameters according to the second protocol and a second command and mapping between a second set of parameters according to the second protocol and a second event representation.

10. The system of claim 7 wherein the relational database is further configured to store a plurality of device templates, each of the device templates configured to contain a set of configuration data, a set of commands, and a set of event representations.

11. The system of claim 10 wherein the device templates are configured to be used by a user interface for receiving user input for customizing device operating parameters and for customizing relations among a plurality of commands and a plurality of events.

12. The system of claim 10 wherein one of the device templates is configured to be used by a code generator to generate the first wrapper.

13. The system of claim 7 wherein the relational database is further configured to store logical relations among a plurality of commands and a plurality of events, the plurality of commands and the plurality of events pertaining to the plurality of devices, the plurality of commands including at least the first command, the plurality of events including at least the one or more events.

14. The system of claim 13 wherein the logical relations include causal relations, and the plurality of commands, and the plurality of events involve at least three devices.

15. The system of claim 13 wherein the logical relations further include at least relations among configuration settings of one or more devices of the plurality of devices, the plurality of commands, and the plurality of events.

16. The system of claim 13 further comprising a control element coupled with the router, the control element configured to intercept at least the first event representation, the control element further configured to generate a forth message based at least in part on the first event representation and on at least a portion of the logical relations, the fourth message configured to be forwarded by the router to a third device for affecting operation of the third device.

17. The system of claim 1 further comprising a second wrapper configured to translate between the second protocol and the first message, the first message further containing at least second device configuration data, the second device configuration data defining operating parameters for the second device.

18. The system of claim 17 wherein the first wrapper and the second wrapper represent copies of a same wrapper.

19. The system of claim 1 further comprising a second wrapper configured to translate between the second protocol and the second message.

20. The system of claim 19 wherein the first command is configured to instruct the first device to perform at least the first action, the first command further configured to instruct the second device to perform at least a second action, the second function different from the first action.

21. The system of claim 1 further comprising a second wrapper configured to translate between the second protocol and the third message.

22. The system of claim 1 further comprising a control element coupled with the router, the control element configured to intercept at least the first event representation, the control element further configured to generate a forth message based at least in part on the first event representation, the fourth message configured to be forwarded by the router to a third device for affecting operation of the third device.

23. The system of claim 1 further comprising a user interface element coupled with the router, the user interface element configured to receive the first message from the second device,
wherein the second device represents a control device, and
the first message is forwarded to the first device by the router.

24. The system of claim 1 further comprising:
a second wrapper configured to translate between the second protocol and a fourth message, the fourth message containing at least second device configuration data, the second device configuration data defining operating parameters for the second device; and
a user interface element coupled with the router, the user interface element configured to receive the first message and the fourth message, the first message forwarded to the first device by the router, the fourth message forwarded to the second device by the router.

25. The system of claim 23 wherein the user interface element is further configured to receive user-specified logical relations among a plurality of commands and a plurality of events, the plurality of commands and the plurality of events pertaining to two or more of the plurality of devices, the user-specified logical relations specified by a user of the first device and the second device.

26. The system of claim 1 further comprising one or more plug-and-play modules coupled with the router, the one or more plug-and-play modules configured to detect a third device of the plurality of devices, the third device coupled with the router through the second device.

27. The system of claim 1 further comprising a server database coupled with the relational database through the Internet, the server database configured to store standard device templates and to provide the standard templates to the relational database.

28. The system of claim 27 wherein the standard device templates are created by developers employed by different enterprises.

29. A method for facilitating automation, the automation involving a plurality of devices, the plurality of devices including at least a first device and a second device, the first device using a first protocol, the second device using a second protocol, the method comprising:
performing at least two of
translating, using a first wrapper, between the first protocol and a first message, the first message containing at least first device configuration data, the first device configuration data defining operating parameters for the first device,
translating, using the first Sapper, between the first protocol and a second message, the second message containing at least a first command, the first command configured to instruct at least one of the first device and the second device to perform at least a first action, and
translating, using the first wrapper, between the first protocol and a third message, the third message containing at least a first event representation, the first event representation configured to describe one or more events, the one or more events involving one or more of the plurality of devices; and
forwarding at least one of the first message, the second message, and the third message between at least the first device and the second device,
wherein the second protocol is different from the first protocol.
